(19) United States
(12) Patent Application Publication
(10) Pub. No.: US 2022/0116404 A1
(43) Pub. Date: Apr. 14, 2022

(54) METHODS AND SYSTEMS FOR ADAPTIVE MULTI-FACTORED GEO-LOCATION BASED DOCUMENT ACCESS RIGHTS MANAGEMENT AND ENFORCEMENT

(71) Applicant: i2Chain, Inc., San Ramon, CA (US)

(72) Inventors: Mark Steven MANASSE, San Francisco, CA (US); Sanjay JAIN, Sammamish, WA (US); Ajay JOTWANI, San Ramon, CA (US); Ananya JAIN, Sammamish, WA (US); Patricia BOLTON, Issaquah, WA (US); Ravi JOTWANI, San Ramon, CA (US)

(21) Appl. No.: 17/209,202

(22) Filed: Mar. 22, 2021

Related U.S. Application Data
(60) Provisional application No. 63/091,652, filed on Oct. 14, 2020.

(51) Int. Cl. H04L 29/06; H04W 12/64; H04W 12/06; H04L 29/08; G01S 19/37

(52) U.S. Cl. CPC H04L 63/107; H04L 63/0876; H04W 12/64; G01S 19/37; H04L 63/062; H04L 67/32; H04L 67/18; H04W 12/06

(57) ABSTRACT

Methods and systems for adaptive multi-factored geo-location based access rights management and enforcement for accessing location restricted data services are described. The method performed by server system includes receiving request to access a data service from a user device associated with a user. The method includes accessing geo-location information associated with the user upon receipt of request. The geo-location information includes geo-location data associated with the user device. The method includes generating geo-location signature associated with the user device, based on the geo-location information. The geo-location signature includes a plurality of location context identifiers. The method includes validating the user device when the geo-location signature and a geo-fence of the data service meet a matching threshold condition and transmitting a response message to the user device based on the validating step. In response to successful validation, the method includes granting access rights to user for accessing the data service.

### TECHNICAL FIELD

The present invention relates to the field of information security, more particularly to the access rights management and enforcement for data services such as sensitive documents, based on the geo-location of an accessing user. A geo-location boundary, henceforth referred to as a geo-fence, is either defined using the coordinates of a plurality of geometric shapes like a rectangle, triangle, etc., or is defined as a geo-political boundary using zip code, city, country, etc. The geo-fence for a sensitive document, that needs to be appropriately secured, is defined at the time of setting or configuring the access policy for the document.

### BACKGROUND

The security of documents, and the associated data, is of high importance as the use of network-based computing for accessing the documents proliferates. For example, a network of computing devices is utilized to provide a robust set of services to their users to provide ease of access and to reduce the cost of storage and services. Generally, corporate, national, and personal documents often contain confidential or private information. Storage of these documents is usually guarded while access to the documents is also limited to certain locations and persons. It is a common practice that companies and people store physical documents in a locked cabinet or a safe. Similarly, the electronic documents are kept in computers within the company premises or at home, and access to these electronic documents is often limited to occur only from within the company office, or from the registered home addresses and networks of authorized users.

Despite the convenience of network-based storage, the risk of theft for data, documents, and identity creates challenges that did not exist with physical documents. Recent privacy-compliance regulations like Europe's GDPR (General Data Protection Regulation), and California's CCPA (California Consumer Privacy Act) require data to be contained within the country, both for storage and access. Information export enforcements like ITAR (International Traffic in Arms Regulations) also require the data export licenses prior to sharing sensitive classified materials with partners and ecosystem outside of the country. Enterprises, governments and service providers retain data in datacenters physically located within the country. However, these entities are unable to enforce users' access to data from outside the boundary, say the country's boundary. For compliance reasons, diverse regulations, and for safely keeping the classified or sensitive information, the information access by the authorized users needs to be further restricted to a certain perimeter or specified bounds.

Hence, there is a need for methods and systems for controlling access to such data services based on the geo-location of accessing users.

### SUMMARY

Various embodiments of the present disclosure provide methods and systems for verifying data access requests based on multi-factored geo-location information.

In an embodiment, a computer-implemented method is disclosed. The computer-implemented method performed by a server system includes receiving a request to access a data service from a user device associated with a particular user. The method includes accessing geo-location information associated with the particular user upon receipt of the request. The geo-location information may include geo-location data associated with the user device. The method includes generating a geo-location signature associated with the user device, based, at least, on the geo-location information. The geo-location signature may include a plurality of location context identifiers. The method further includes validating the user device when the geo-location signature and a geo-fence associated with the data service meet a matching threshold condition and transmitting a response message to the user device based on the validating step.

In another embodiment, a server system is disclosed. The server system includes a memory configured to store instructions, a communication interface, a processor in communication with the memory and the communication interface, and the processor is configured to execute the instructions stored in the memory and thereby cause the server system to receive a request to access a data service from a user device associated with a particular user. The server system is caused to access geo-location information associated with the particular user upon receipt of the request. The geo-location information may include geo-location data associated with the user device. The server system is further caused to generate a geo-location signature associated with the user device, based, at least, on the geo-location information. The geo-location signature may include a plurality of location context identifiers. The server system is caused to validate the user device when the geo-location signature and a geo-fence associated with the data service meet a matching threshold condition and transmit a response message to the user device based on the validation.

In yet another embodiment, a computer-implemented method for adaptive multi-factored geo-location based data service access rights management and enforcement is disclosed. The computer-implemented method performed by a server system includes receiving a request to access a data service from a user device associated with a particular user. The method includes accessing geo-location information associated with the particular user upon receipt of the request. The geo-location information may include geo-location data associated with the user device. The method further includes generating a geo-location signature associated with the user device, based, at least, on the geo-location information. The geo-location signature may include a plurality of location context identifiers. The method includes validating the user device when the geo-location signature and a geo-fence associated with the data service meet a matching threshold condition and transmitting a response message to the user device based on the validating step.

### BRIEF DESCRIPTION OF THE FIGURES

For a more complete understanding of example embodiments of the present technology, reference is now made to the following descriptions taken in connection with the accompanying drawings in which:

FIGS. 1A & 1B are example representations of environments related to at least some examples of the present disclosure;

FIG. 2 is a simplified block diagram of a server system, in accordance with an embodiment of the present disclosure;

FIG. 3 is a sequence flow diagram for validating access requests for data service from a user device using location-based validation methods, in accordance with an embodiment of the present disclosure;

FIG. 4 is a flowchart of a process flow for validating geo-location data of a user device, in accordance with an embodiment of the present disclosure;

FIG. 5 is an example representation depicting the communication between an authenticator and a receiver linked to a source of signal, in accordance with an embodiment of the present disclosure;

FIG. 6 is an example representation for validating a user device to access a data service from the server system, in accordance with an example embodiment of the present disclosure;

FIG. 7 is a flow diagram of a method for verifying data access requests by location-based validation, in accordance with an embodiment of the present disclosure; and

FIG. 8 is a simplified block diagram of an electronic device, in accordance with an embodiment of the present disclosure

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

One approach to limit access to online documents or data services is to utilize username and password confirmation. Username/password confirmation does provide a decent amount of security, however, when unapproved users are told or in any case get the username and password of actual users, the documents can be easily accessed and misused by unapproved users. Further, another approach to restrict access is location based. Certain documents such as sensitive government documents, personal secret documents such as asset details or medical diagnoses or treatments of a user may be required to be restricted based on location. These types of documents may be accessed only if the user and the user device accessing the documents are adjudged to be within a specific geo-boundary.

However, with the growth of technology, applications and software tools have been designed that could fake a simple location check by using fake IP addresses and remotely logging on to the location services near to the desired location. A deceptive virtual private network (VPN) may also be used to get access to a restricted document by reporting fraudulent locations. Given that the service remains at a fixed location, we must rely on the user devices to faithfully report the location information they receive.

In view of the foregoing discussion, various example embodiments of the present disclosure provide methods, systems, user devices, and computer program products for validating location of a user device using multiple factors and then allowing/denying access to sensitive documents based on the configured geo-fence policies.

In various example embodiments, the restricted data services may be government services website that may receive requests from users to utilize such services, which may be restricted only to users in certain jurisdictions. In one example, only users in a particular country or state may be allowed to consume content online from a website.

In various example embodiments, the present disclosure describes a server system that is configured to receive a request to access a data service from a user device associated with a user. A Secured Data Access Management (SDAM) application may be provided by the server system to be downloaded onto the user device. The application may facilitate the user device with various functionalities such as registering to the server system for accessing data services, accessing documents and/or data services, adding trusted devices and physical locations, and the like. In an embodiment, when the server system receives the request to access the data service from the user device, the server system checks if the user and the user device are registered to access the requested data service or not.

In one embodiment, if the user and the user devices are found to be registered, the server system is configured to receive geo-location information from a receiver associated with the user device. The receiver may be an entity linked to a source of signal such as a GPS satellite. In some embodiments, a command may be automated to send a request to the receiver for the geo-location information of the user device. The geo-location information may include the geo-location data of the user device determined from the source of signal such as a GPS satellite. The geo-location information may be requested by the server system on the receipt of the request to access the data service.

In the embodiment, the server system may further receive a hidden secret key associated with the source of signal such as the GPS satellite, from an authenticator. The hidden secret key may correspond to a current or the most recent signal transmissions from the GPS satellite and is associated with an interval of broadcast times. The server system validates the hidden secret key received from the authenticator to make sure that the signal was received from a trusted GPS satellite.

The authenticator is composed of a single server or plurality of servers expected to have a faster connection to clients or user devices than any satellite, which serves to relay recently broadcast GPS satellite hidden secret keys to clients. The clients may use the hidden secret keys to validate prior satellite transmissions. As such, the authenticator relays the previously hidden secret keys and satellite identifiers of trusted GPS constellations to ensure that the constituent identities of the trusted sources of location information are well known using terrestrial communication bandwidth. The authenticator servers are used to reduce the use of scarce communication bandwidth from satellites; broadcasts of GPS timestamps are normal and expected, but direct communication from GPS receivers to satellites is difficult, and requires more powerful transmission capabilities than those available to the typical mobile device. In general, the purpose of the set of authenticator servers is to provide a terrestrial high-bandwidth communication nexus to establish the validity of transmissions establishing location, and to record the locations of devices that might be expected to be proximate to a user because of collective membership in an organization to which the user belong.

In one embodiment, the server system is configured to generate a geo-location signature associated with the user device based on the geo-location data included in the geo-location information of the user device. The geo-location signature includes adaptive acquisition of a plurality of location context identifiers such as GPS, IP address, network routing information, location of the nearby trusted devices, photographic evidence of a user's presence at a specific location (e.g. captured by street cameras or drones etc.) etc. The geo-location signature of the user device may be generated based on the validation of location using the hidden secret key received from the authenticator. The confidence level score of the geo-location signature accuracy is determined by comparing location information obtained from the various location context identifiers. The confidence level score increases if more than one and preferably several of the location context identifiers return the similar values to the extent of their own accuracy levels.

In one embodiment, after the validation of the geo-location signature of the user device, the server system is configured to compare the geo-location signature with a geo-fence set for the data service. The geo-fence for a data service may be defined based on an access geo-location and an access policy. The access geo-location may correspond to the specific location such as office, home, etc. The access policy may include pre-defined rules for generating the geo-fence such as the maximum allowed radius, time constraints, a threshold condition, etc. In the embodiment, when the geo-location signature and the geo-fence do meet the matching threshold condition, the server system may allow the user device access to the data service requested by the user. In another embodiment, when the geo-location signature and the geo-fence policy do not meet the matching threshold condition, the server system is configured to send an error message denying access to the data service requested by the user.

Based on the confidence level score and the validation result, access to the data service is allowed or denied.

Various embodiments of the present disclosure offer multiple advantages and technical effects. For instance, for granting/denying access to a data service, the present disclosure validates user device's geo-location data. To add to the security, the present disclosure not only validates the geo-location of the user device but also utilizes the hidden secret keys generated by the sources of signals such as the GPS satellites to authenticate the signals received from the GPS satellites. The hidden secret keys make sure that the GPS location associated with the user device, received by the server system, is from a trusted source of signal such as a trusted GPS satellite. Further, the present disclosure utilizes authenticators for helping distribute the recently used hidden key secrets by each GPS satellite, and helping to authenticate the putative satellites.

The present disclosure further facilitates moving most of the communications to a terrestrial server with better bandwidth, and pseudonymously relaying the reported terrestrial locations of user devices belonging to other members of a user's organization. The present disclosure reports these locations pseudonymously to preserve the privacy of other users (and to avoid adding a spying tool useful to private investigators) but nonetheless those from the user's organization can assist in evaluating the trustworthiness of location reports and to enhance the odds of finding those co-workers sharing rough locations. The authenticator can also provide a blackboard for recording other information of use to an organization serving to provide a reliable and trusted repository for communicating location information between users belonging to that organization, including identifying the satellites composing a trusted GPS constellation.

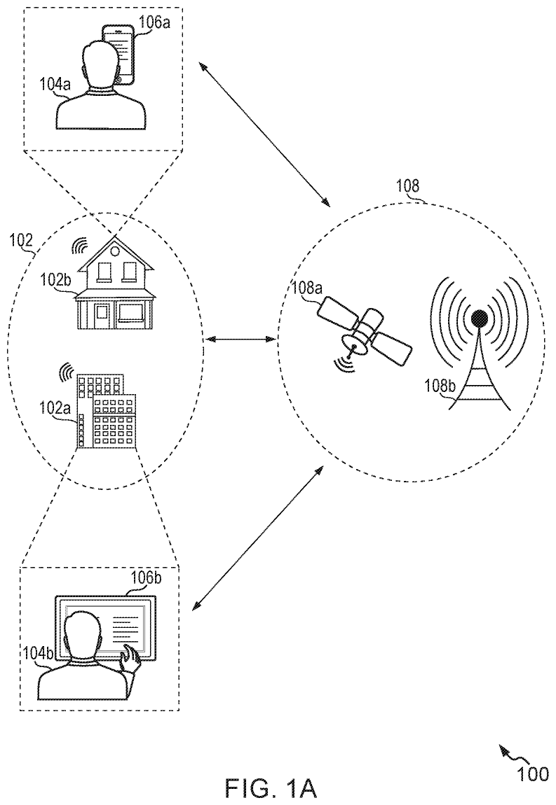

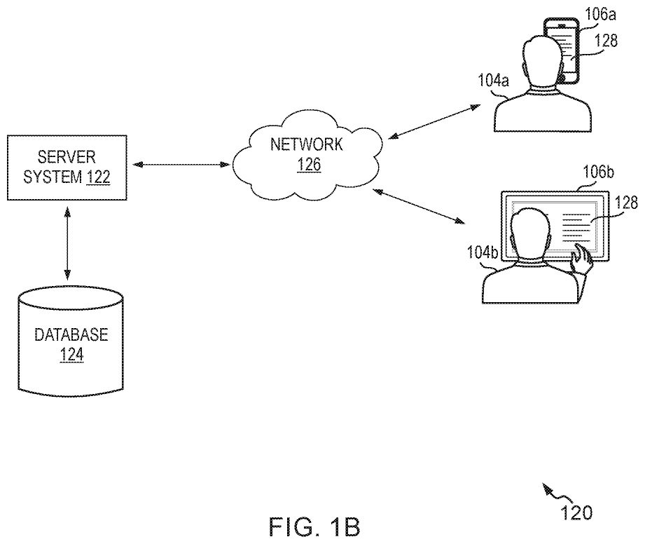

Various example embodiments of the present disclosure are described hereinafter with reference to FIGS. 1 to 8.

FIG. 1A is an example representation of an environment 100 related to at least some examples of the present disclosure. Although the environment 100 is presented in one arrangement, other embodiments may include the parts of the environment 100 (or other parts) arranged otherwise depending on, for example, facilitating multi-factored geo-location based validation of requests to access data services, etc. Various user devices can be located in a structure 102, for example, office building 102a, a house 102b, or other location that user 104a and the user 104b may be associated with. For illustration purposes, the user devices 106a and 106b are shown to be used by the users 104a and 104b, respectively. However, it is understood that the same principles can apply to other environments.

The environment 100 may also include sources of signals 108. Examples of the sources of signals 108 may include, but are not limited to, global positioning system (GPS) satellites 108a (for clarity purposes, only one GPS satellite is shown in the FIG. 1A), and cellular base stations 108b. The user devices 106a and 106b can incorporate cellular telephone technology to communicate with a cellular base station 108b for voice calls and/or cellular data. The user device may incorporate global positioning satellite (GPS) technologies, e.g., using signals received from the GPS satellite to determine geo-location information representative of the location of the user device. Other details of the user device are described with reference to FIG. 1B below.

The GPS satellite 108a and the cellular base station 108b may be configured to determine locations of the plurality of user devices. Only one satellite and a cellular base station are shown in the figure for illustration purposes, whereas more than one satellite and cellular base station may be necessary for providing location services on the user devices 106a and 106b.

In some embodiments, the security level (and/or other device settings) on a user device can vary based on the user device's location and/or what is proximate to the user device.

The security level (or other device settings) can be modified based on the detected geo-location of the user device 106a. The term “geo-location” can include any parameter or attribute that can help in determining the location of the user device 106a. The geo-location data can include many features or attributes of a location, including networks that are visible to the user device 106a, networks that the user device 106a can connect to, devices that are visible on a particular network, or challenge/response on the network. For example, a home Wi-Fi network may help define a “residence” location.

FIG. 1B is another example representation of an environment 120 related to at least some examples of the present disclosure. Although the environment 120 is presented in one arrangement, other embodiments may include the parts of the environment 120 (or other parts) arranged otherwise depending on, for example, facilitating multi-factored geo-location based validation of access requests to access data services. The environment 120 generally includes the users 104a and 104b associated with the user devices 106a and 106b (as shown in FIG. 1A), a server system 122, and a database 124 each connected to, and in communication with (and/or with access to) a network 126. The network 126 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1B, or any combination thereof.

Various entities in the environment 120 may connect to the network 126 in accordance with various wired and wireless communication protocols, such as, Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. The network 126 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1B, or any combination thereof. For example, the network 126 may include multiple different networks, such as a private network made accessible by the user devices 106a an 106b, the server system 122, and the database 124 separately, and/or a public network (e.g., the Internet) through which the user devices 106a and 106b, the server system 108, and the database 124 may communicate. In some embodiments, the user devices 106a and 106b may, for example, be connected to the server system 122 via various wireless means such as, cell towers, routers, repeaters, ports, switches, and/or other network components that comprise the Internet and/or a cellular telephone (and/or Public Switched Telephone Network (PSTN)) network, and which comprise portions of the network 126.

In one embodiment, the user devices may comprise any type or configuration of computing, mobile electronic, network, user, and/or communication devices that are or become known or practicable. Examples of the user device include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like. Each user device may can include an ultrasound sensor, a global position satellite transceiver, WiFi transceiver, mobile telephone components, and/or any suitable combination thereof. In some embodiments, the user devices 106a and 106b may include devices owned and/or operated by the users 104a and 104b of an online service. According to some embodiments, the user devices 106a and 106b may communicate with the server system 122 via the network 126, such as to register with a service provider, request access to online data services, and/or transmit information about the location of the user devices 106a and 106b. The user devices 106a and 106b can have unique device identifiers including MAC addresses, supported services/protocols, available ports, ports in use, etc.

In one embodiment, the user device (e.g., the user device 106a) is equipped with Secured Data Access Management (SDAM) application 128, interchangeably referred to as “mobile application” throughout the description. The SDAM application 128 manages and controls data access services. The user device (e.g., the user device 106a) may be any communication device having hardware components for enabling User Interfaces (UIs) of the SDAM application 128 to be presented on the user device (e.g., the user device 106a).

In an embodiment, the server system 122 may provide software backend APIs corresponding to the SDAM application 128 which instructs the server system 122 to perform one or more operations described herein. In addition, the server system 122 should be understood to be embodied in at least one computing device in communication with the network 126, which may be specifically configured, via executable instructions, to perform as described herein, and/or embodied in at least one non-transitory computer-readable media. The SDAM application 128 is an application/tool resting at the server system 122. In one embodiment, the server system 122 is configured to host and manage the SDAM application 128 and communicate with the user devices (e.g., the user devices 106a and 106b) for providing an instance of the SDAM application 128. The SDAM application 128 may facilitate, for example, an online content provision website, online voting service, or a government services website that may receive requests from users to utilize such services, which may be restricted to users in certain jurisdictions. In one example, only users in a particular country or state may be allowed to consume content online from a website authorized to provide online content services in that jurisdiction.

In one embodiment, the server system 122 is configured to control access for data services by utilizing location-based access rights grant technology. The server system 122 is configured to determine, analyze, and/or validate a geo-location of the user devices 106a and 106b associated with the users 104a and 104b, respectively. In one example, the server system 122 may determine whether a user requesting for a restricted access service is in an area where that service can be provided, and if so, the server system 122 may permit the user to access the service. In an embodiment, the server system 122 may be configured to register the users 104a and 104b, via the SDAM application 128.

In one embodiment, the user (e.g., the user 104a) may send a request for accessing an online data service (e.g., electronic document) to the server system 122 using the SDAM application 128.

In one embodiment, the electronic document being accessed may be a corporate document such as an agreement, a contract, an official letter, a client letter, a corporate email, a software program, a report, a sales presentation, meeting notes, a memorandum, a partnership contract, a transcript, a product list, a product manual, an internal memo, a customer order, a human resource document, a performance review, a candidate interview report, a financial report, a document related to sales data, a directory, a blueprint, a prototype specification, a piece of software source code, or a confidential document. In one embodiment, the electronic document may be a personal electronic document or belonging such as a medical record, a bill, a bank statement, a will, a monthly statement, a manuscript, a photo, an electronic identity document, a tax return, a business plan, a picture, an electronic painting, a piece of writing, a certificate, a sales receipt, an invoice, a lease agreement, a grant deed, a loan agreement, a letter, an electronic book, a work document, a song, an album, a business document delivered to a person over a data network, or a document a person stores in a data network. In another embodiment, the electronic document may be a commercial electronic document related to a purchase transaction such as a picture, an electronic book, a video, a song, an album, an invoice, a lease, an agreement, a letter, a user guide, a product specification, a manual, a receipt, a delivery notification, a message, a voice mail, a purchase order, or other transaction documents. Further, in another embodiment, the electronic document may include a virtual coin, or virtual currency. Furthermore, the electronic document may include private information, personal identity, personal or corporate sensitive information, credit card information, or any information requiring designated access location. In one embodiment, the electronic document includes national security-related classified documents, e-mails and/or presentations.

The server system 122 is configured to provide access for the data service to the users by multi-factored geo-location based validation. The server system 122 may be utilized to determine and/or verify geo-locations of user devices requesting to access data services restricted to access from particular locations. In particular, the server system 122 is configured to validate access requests to access online data services by determining geo-location data of the users, using one or more location data indicators. The one or more location data indicators may include the GPS service, device IP address, nearby cell towers' location, prior authenticated devices, and more of the computer requesting the access as well as triangulating the information with the user's other trusted or registered end-user devices such as mobile phone, laptop, etc. The server system 122 is configured to determine a location of the user based, at least in part, on probabilities of veracities/confidence level score corresponding to each location indicator of the user devices and with known degrees of trust and known failure models.

In other words, the server system 122 is configured to implement multi-factored geo-location based validation for accessing a secured document stored at the database 124. The multi-factored geo-location based validation may utilize the GPS service, device IP address, nearby cell towers' location, prior authenticated devices, etc.

In one example embodiment, a confidence level score corresponding to the determined geo-location signature is calculated by the server system 122. The server system 122 is configured to calculate the confidence level score based on a number of pre-defined possible spoofing scenarios (flags). The possible spoofing flags correspond to a severity level ranging from a scale of one to five, one being the least severe and the five being the highest severe. The severity refers to the level of spoofing that the location of a user device such as the user device 106a is indicating. Further, the server system 122 is configured to perform summation of the severity levels that the user device 106a is flagged for and determine an intermediate number ranging from zero to a predetermined maximum such as, twenty in the currently envisioned severity levels. Finally, the sum is converted into a final confidence score in the form of a percentage, using a logarithmic formula in today's implementation.

In one example, the flags may include: 1) extreme location jump for a mobile phone, 2) Mobile-computer discrepancy for mobile phone and computer, 3) Geo-IP country discrepancy for mobile phone and computer (i.e., the country that the user's current public IP address maps to is not the same as the country obtained by reverse geocoding their geo-location coordinates), 4) Unreliable IP address for mobile phone and computer (i.e., the user's current public IP address was looked up using a third-party service, and that service reported that the user is likely masking their IP address using a VPN, proxy server, Tor exit node, or other technique, 5) Straight coordinate path for mobile phones (i.e., All of the coordinate readings retrieved on the user's mobile device during a certain geo-location attempt lie along either a perfectly straight line (measured by slope) or a perfect great-circle arc (measured by bearing)), 6) Computer geo-location unavailable for computer (i.e., The user's computer/laptop geo-location was unable to be obtained using the HTMLS Geo-location API.).

The server system 122 is configured to determine whether a user (e.g., user 104a) is allowed or denied access to the content of data service based on the determined location of the user device (e.g., user device 106a).

In one example, for the GPS service, the server system 122 is configured to receive the geo-location data of the user device 106a associated with the user 104a from the GPS satellite 108a. The server system 122 is configured to analyze the geo-location data from the GPS satellite 108a to determine a geo-location of the user device. The analysis may include various processes such as determining the orbital geometry of the satellites and the like. The server system 122 may be coupled to an authenticator and at least one receiver linked to the GPS satellite 108a. The receiver determines a geo-location estimate by analyzing signals from transmitters such as but not limited to GPS satellite 108a. In an exemplary scenario, upon receiving the request from the user device 106a to access the data service with location restricted access, the server system 122 may initiate a multi-factored geo-location based validation process.

According to an embodiment, the server system 122 may determine whether a user is associated with a registered user device in order to initiate the geo-location validation process. As part of a geo-location validation process, the server system 122 may communicate with the authenticator linked to the GPS satellite 108a to validate the geo-location of the user device 106a that is requesting access of the electronic document. Once the geo-location has been determined for the user device 106a, the determined geo-location is used to regulate access to the electronic document.

The server system 122 may generate a geo-fence for the corresponding data service using an access geo-location and an access policy associated with the data service. The access geo-location may correspond to the specific location such as office, home, etc. The access policy may include pre-defined rules for generating the geo-fence such as the maximum allowed radius, time constraints, a threshold condition, etc. The server system 122 may compare a geo-fence generated based on the access-geo-location and the access policy with the geo-location signature of the user device. The server system 122 may then approve or decline the access request for accessing the data service, received by the user device 106a based on the comparison.

The number and arrangement of systems, devices, and/or networks shown in FIG. 1B are provided as an example. There may be additional systems, devices, and/or networks; fewer systems, devices, and/or networks; different systems, devices, and/or networks; and/or differently arranged systems, devices, and/or networks than those shown in FIG. 1B. Furthermore, two or more systems or devices shown in FIG. 1B may be implemented within a single system or device, or a single system or device shown in FIG. 1B may be implemented as multiple, distributed systems or devices. Additionally, or alternatively, a set of systems (e.g., one or more systems) or a set of devices (e.g., one or more devices) of the environment 120 may perform one or more functions described as being performed by another set of systems or another set of devices of the environment 120.

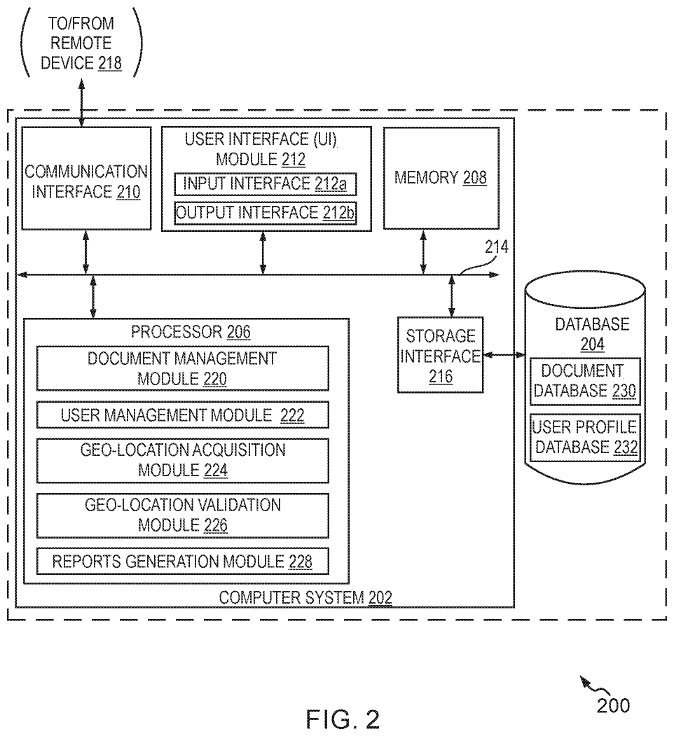

FIG. 2 is a simplified block diagram of a server system 200, in accordance with an embodiment of the present disclosure. For example, the server system 200 is similar to the server system 122 as described in FIG. 1B. In some embodiments, the server system 200 is embodied as a cloud-based and/or SaaS-based (software as a service) architecture. The server system 200 is configured to use multi-factored geo-geo-location information to determine the access rights for accessing data service associated with a document, folder, file system, or cloud by a user device.

In one embodiment, the server system 200 includes a computer system 202 and a database 204. The computer system 202 includes at least one processor 206 for executing instructions, a memory 208, and a communication interface 210. The computer system also includes a user interface (UI) module 212. The one or more components of the computer system 202 communicate with each other via a bus 214.

In one embodiment, the database 204 is integrated within the computer system 202. For example, the computer system 202 may include one or more hard disk drives as the database 204. A storage interface 216 is any component capable of providing the processor 206 with access to the database 204. The storage interface 216 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 may include a document database 230 including a plurality of electronic documents and a user profile database 232.

The processor 206 includes suitable logic, circuitry, and/or interfaces to execute computer-readable instructions for facilitating multi-factored geo-location based validation of a request initiated by a user device for accessing a data service. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In some embodiments, the memory 208 may be realized in the form of a database server or a cloud storage working in conjunction with the server system 200, without deviating from the scope of the present disclosure.

The processor 206 is operatively coupled to the communication interface 210 such that the processor 206 is capable of communicating with remote device 218 such as, user devices, a receiver and an authenticator associated with source of signal, etc. or with any entity connected to the network 126 (e.g., as shown in FIG. 1B).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a document management module 220, a user management module 222, a geo-location acquisition module 224, a geo-location validation module 226, and a reports generation module 228.

The UI module 212 may be in communication with the database 204. The UI module 212 is configured to present one or more UIs for facilitating encryption of shared information through its lifecycle. The UI module 212 includes an input interface 212a and an output interface 212b. The input interface 212a is configured to receive one or more documents that are to be remotely stored. The input interface 212a is also configured to receive user details associated with each user. Further, the input interface 212a is also configured to receive requests for accessing one or more stored documents from one or more users (e.g., the user 104a) of FIG. 1B. Examples of the input interface 212a may include but are not limited to a keyboard, a mouse, a joystick, a keypad, a touch screen, soft keys, a floppy disk, a pen drive, a hard drive and the like. The output interface 212b is configured to facilitate accessing of the one or more documents by the users 104. In an embodiment, the output interface 212b is configured to display one or more documents to the current user and the one or more next users. Examples of the output interface 212b may include, but are not limited to, a display such as a light emitting diode (LED) display, a thin-film transistor (TFT) display, a liquid crystal display, an active-matrix organic light-emitting diode (AMOLED) display, and the like. In an embodiment, the input interface 212a and the output interface 212b are based on application programming interfaces (APIs). In an example, the input interface 212a can receive input data and the output interface 212b can provide output data via API calls.

The document management module 220 includes suitable logic, circuitry, and/or interfaces to execute computer-readable instructions for managing the plurality of documents stored in the document database 230. The document management module 220 may be in communication with the database 204. The management of the plurality of documents includes the management of location access rights of each document and management of the users of each document as per the location restrictions. In other words, the document management module 220 may also store a number of access geo-locations associated with the plurality of documents.

The user management module 222 includes suitable logic, circuitry, and/or interfaces to execute computer-readable instructions to manage the users 104 such as management of documents stored by each current user as per the location access to the associated user devices. The user management module 222 is configured to generate and maintain profiles of each user and the user devices. The user management module 222 is in communication with the database 204.

In one embodiment, the processor 206 is configured to receive a request to access a data service (e.g., document) from a user device (e.g., user device 106a) associated with a particular user (e.g., user 104a). Upon receipt of the request, the processor 206 is configured to access geo-location information associated with the particular user (e.g., user 104a). The geo-location information may include, but not limited to, geo-location data of the user device, device identifier (such as, IP address), etc.

The document management module 220 may check whether the data service for which the access is requested by the user device 106a requires a geo-location validation or not. The document management module 220 may also check the location access right of a data service such as an electronic document stored in the document database 230.

In particular, the processor 206 is configured to check if the user 104a is a registered user who is requesting the access from a registered user device. The user management module 222 may be in communication with the user profile database 232 to check if the user 104a and the user device 106a are registered with the server system 200 and are eligible for accessing the data service such as an electronic document.

Once the user management module 222 determines that the user 104a and the user device 106a are registered on the SDAM application 128, the processor 206 may initiate a communication with the receiver associated with the GPS satellite and receive geo-location information from the user device 106a.

The geo-location acquisition module 224 includes suitable logic, circuitry, and/or interfaces to execute computer-readable instructions for receiving the geo-location data from receivers (such as, a receiver associated with a GPS satellite or any other access points or source of signal). The receivers may be a geo-location data source, such as GPS receiver, wireless devices (e.g., Wi-Fi routers), basic service set identification (BSSID) location service, and/or carrier mobile tower(s) using the cellular radio of the user device. The source of signal is configured to transmit the determined location data to the geo-location acquisition module 224 and/or geo-location validation module 226 for geo-location analysis.

In one embodiment, the geo-location data is determined based on one or more location indicators such as, GPS service, IP addresses, nearby cell towers' location, and prior authenticated user devices, etc.

In one example, the receiver may be an entity linked to the source of signal (i.e., the GPS satellite 108a) that is in communication with the user device 106a. Examples of the geo-location data transmitted from the receiver to the geo-location acquisition module 224 include, without limitation, raw GPS satellite signals, identification information for at least one GPS satellite, latitude and longitude coordinates, timestamps, or any other information that may be useful in determining and/or verifying the geo-location of the user device. In some examples, the geo-location data may be digitally signed by the receiver using, for example, secure sockets layer (SSL) or transport layer security (TLS), government-issued private encryption key. SSL and TLS are the standard technologies available in the art for securing connection and safeguarding any sensitive data that is being dispatched amongst the systems, and stopping fraudsters from accessing and/or modifying the data being transferred, but are likely to be augmented or replaced over time as deficiencies are revealed or discovered. In an additional embodiment, quantum-resistant alternatives may be proposed to address known attacks using quantum computing on key distribution and encryption algorithms The receiver may be in communication with the user device 106a, and/or the GPS satellite 108a.

The geo-location validation module 226 includes suitable logic, circuitry, and/or interfaces to execute computer-readable instructions for validating geo-location data to generate a geo-location signature associated with the user device 106a. The validation of the geo-location data may be performed in a variety of ways, including, for example, 1) by determining whether the signal strengths of the raw GPS satellite signals exceed a predetermined threshold value, 2) by determining whether the signal strengths of the raw GPS satellite signals vary by more than a predetermined threshold value and/or 3) by comparing the signal strengths of the raw GPS satellite signals with a known location of at least one GPS satellite 108a responsible for generating the raw GPS satellite signals. Since the geo-location data may be digitally signed to ensure its integrity, the geo-location validation module 226 may decipher the digitally signed geo-location data using a government-issued public decryption key.

The geo-location validation module 226 is configured to determine, analyze, and/or validate a current location of the user device 106a associated with the user 104a. The geo-location validation module 226 is configured to first validate the geo-location data for the current or recent messages by communicating with an authenticator linked to the GPS satellite 108a. The authenticator may be configured to access a hidden secret key that is used to sign the transmissions (between the user device and the GPS satellite 108a) with the device address and is known only to the GPS satellite 108a at the time of transmission of a timestamp from the GPS satellite 108a. Following this transmission, the authenticator is configured to transmit the previously hidden secret key of the current signal or the signals that were recently originated, to the server system 200. In general, the authenticator is configured to store and distribute the hidden secret keys employed by the GPS satellites, allowing the receivers to validate that the signals originated from the GPS satellites are legitimate and known to the authenticator. An authenticator at a single fixed location is in receiving range for at most half the satellites in a trusted GPS constellation, and consequently relies on reports of revealed keys from clients.

The geo-location validation module 226 is configured to analyze the hidden secret keys to match an orbital geometry associated with the GPS satellite for a current signal with a known orbital geometry of the GPS satellite. In response to a successful match, the geo-location validation module 226 is configured to calculate the difference between the time at which the signals were sent and estimates the distance from the expected position of the satellite at the time of transmission to the user device 106a, and then employs one or more geometric techniques and the speed of light to locate the point at the intersection of one or more spheres surrounding the known orbital position of the GPS satellites. The radius of the sphere is determined as the distance covered at the speed-of-light during the calculated time of difference. The calculated time of difference is the difference in time between the time of receipt of messages and the satellite's time.

Further, the geo-location validation module 226 is configured to determine geo-location associated with a geo-location signature of the user 104a. The geo-location signature may include a plurality of location context identifiers associated with the user device 106a. The plurality of location context identifiers may include GPS, IP address, network routing information, nearby trusted devices, and the like.

In one embodiment, the geo-location validation module 226 is configured to compare the geo-location signature with the geo-fence in the access policy associated with the corresponding data service. The comparison may include checking whether the geo-location signature meets a matching threshold condition with the geo-fence in the access policy. The matching threshold condition may be defined based on the location context identifiers in the geo-location signature. For example, if the GPS location lies inside the geo-fence, etc.

Further, in response to successful validation, the geo-location validation module 226 is configured to allow access to the user device for the data service. In case if the validation is not successful, the geo-location validation module 226 is configured to deny the access for the data service. If the access is denied, an error message may be transmitted to the user device 106a from the sever system 200, with a denied access message to the data service.

In an additional embodiment, the geo-location validation module 226 is configured to calculate a confidence level score corresponding to the geo-location in the geo-location signature associated with the user. The server system 200 is configured to calculate the confidence level score based on a number of pre-defined possible spoofing scenarios (flags). Each pre-defined possible spoofing scenario (flag) corresponds to a severity level ranging from a scale of one to five (illustrative only; any numeric range or set of grades would work), one being the least severe and the five being the most severe. The severity refers to the level of spoofing that the location of the user device is indicating. Further, the geo-location validation module 226 is configured to perform summation of the severity levels that the user device is flagged for and determine an intermediate number ranging from zero to a predetermined maximum such as, twenty in the currently envisioned severity levels. Finally, the sum is converted into a final confidence score in the form of a percentage.

The document management module 220 in connection with the communication interface 210 may be configured to send the requested document/data service to the user device 106a or provide access to the requested data service remotely on the user device 106a based on the restrictions stored in the document database 230.

The reports generation module 228 is configured to generate reports in a variety of ways, for example, including 1) a report of failed document accesses that includes, but is not limited to one or more of user devices making the failed accesses, current locations of the access devices, times of the access requests, document identities of access requests, and user information of the user devices, 2) a report of successful document accesses that includes, but is not limited to, one or more of access devices making the successful accesses, current locations of the access devices, times of the access requests, document identities of access requests, and user information of users of the user devices, 3) a report of failed document storage requests, 4) a report of successful document storage requests, 5) a report of access requests for a time period, or other reports of tracked access and storing activities. The reports generated may be used to analyze and use the data for future improvements and updates in the system.

In one embodiment, the reports may be used to trace a security breach involving a sensitive document, to trace the activity of a specific user device, to track storage of or accesses to a specific document, and to verify that a document was delivered successfully to a user device at a location matching the access location associated with the document.

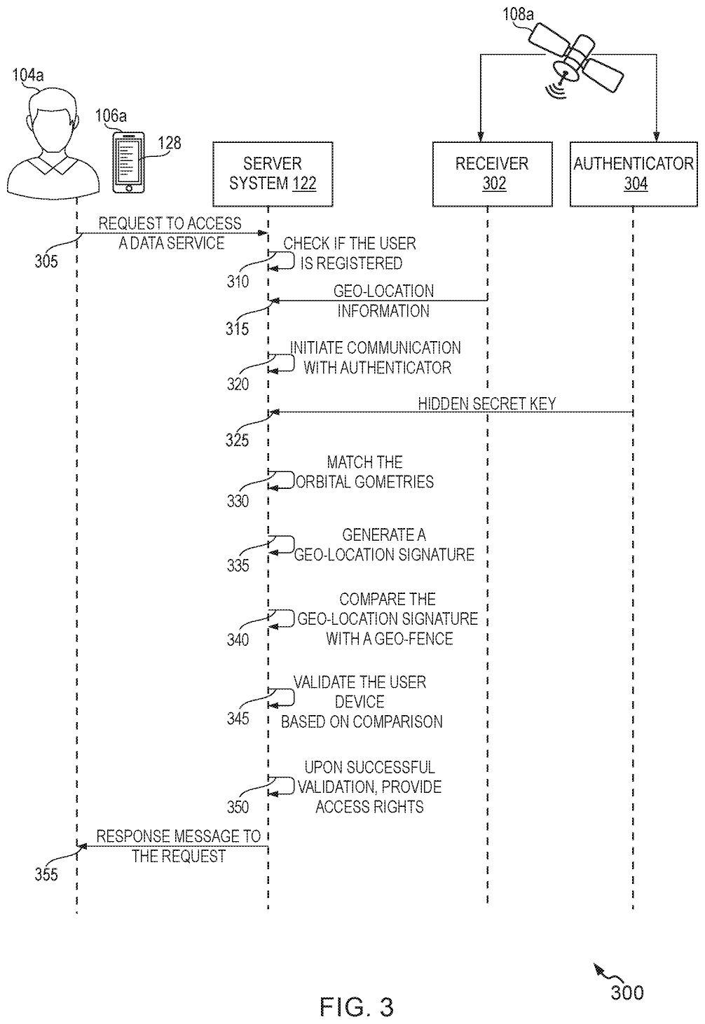

FIG. 3 is a sequence flow diagram 300 for validating access requests for data service from a user device (e.g., user device 106a) using location-based validation methods, in accordance with an embodiment of the present disclosure. The steps of the sequence flow diagram 300 may not be necessarily executed in the same order as they are presented. Further, one or more steps may be grouped and performed in form of a single step, or one step may have several sub-steps that may be performed in parallel or in a sequential manner.

At 305, the user device 106a sends a request to access a data service to the server system 122. The request may be initiated by the user 104a using the SDAM application 128 downloaded on the user device 106a. In one example, the data service may be an electronic document with location restricted access. The request may include user profile details of the user 104a and data service identifier.

At 310, the server system 122 checks whether the user 104a is an already registered user or not. In other words, the server system 122 checks the authenticity of user profile details by searching user profile details in the user profile database. In case, if the user 104a is not the already registered user, the server system 122 may facilitate the installation of the SDAM application 128 on the user device 106a.

At 315, the server system 122 accesses geo-location information from a source such as a receiver 302 linked to a GPS satellite 108a. The GPS satellite 108a is in communication with the user device 106a. The geo-location information may include geo-location data associated with the user device 106a during the initiation of the request to access the data service. Examples of the geo-location data include, without limitation, raw GPS satellite signals, identification information for at least one GPS satellite, latitude and longitude coordinates, timestamps, or any other information that may be useful in determining and/or verifying the geo-location of the user device. In some examples, the geo-location data may be digitally signed by the receiver using, for example, a secure sockets layer (SSL) or transport layer security (TLS), or a government-issued private encryption key. The receiver may be in communication with the user device 106a, and/or the GPS satellite 108a.

At 320, the server system 122 initiates a communication with an authenticator linked to the GPS satellite 108a. The authenticator is configured to store and distribute the hidden secret keys employed by the GPS satellites, allowing the receivers to validate that the signals originated from the GPS satellites known to the authenticator.

At 325, the server system 122 receives the hidden secret key from the authenticator. The hidden secret key is used to authenticate a transmission as having been sent from a particular GPS satellite during the time interval while the key was still hidden.

At 330, the server system 122 matches an orbital geometry associated with the GPS satellite 108a for a current signal with a known orbital geometry of the GPS satellite 108a. The matching is performed to check if the geo-location data is received from a legitimate GPS satellite or not. In case the GPS satellite 108a is not legitimate, the process flow stops and an error message is transmitted to the user device 106a with denying access of the data service.

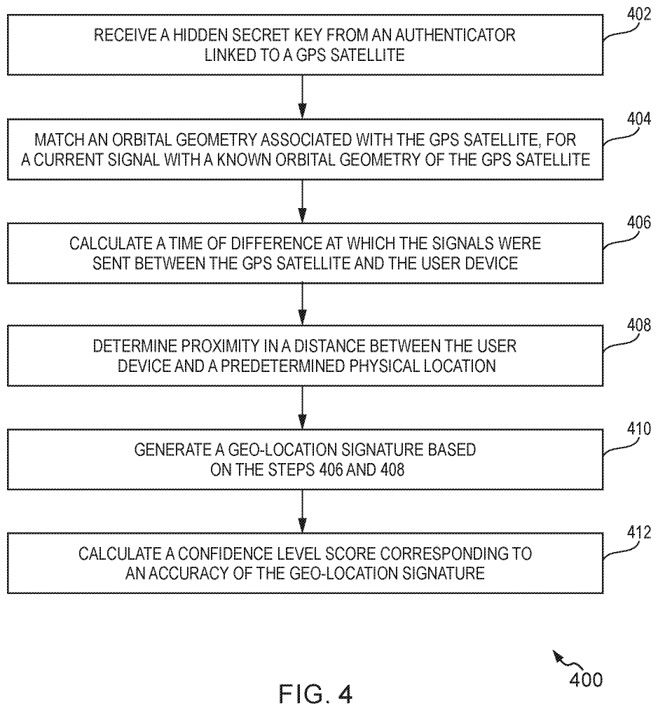

At 335, the server system 122 generates a geo-location signature of the user device 106a when the orbital geometry of the GPS satellite 108a matches with the known orbital geometry of the GPS satellite. The geo-location signature, associated with the user device 106a, includes adaptive acquisition of a plurality of location context identifiers such as GPS, IP address, network routing information, location of the nearby trusted devices etc. A detailed explanation of generating the geo-location signature of the user device is provided with reference to the FIG. 4.

At 340, the server system 122 compares the geo-location signature with a geo-fence defined in the access policy associated with the data service. The comparison may include checking whether the geo-location signature meets a matching threshold condition with the geo-fence in the access policy.

At 345, the server system 122 validates the user device 106a based on the comparison. The server system 122 may validate the user device if the geo-location signature and the geo-fence in the access policy meet a matching threshold condition. The matching threshold condition may be one of a predetermined threshold distance between the geo-locations or a certain radius from the access geo-location, and/or the like.

At 350, upon successful validation, the server system 122 allows access to the user device 106a for the data service. In some embodiments, a document may be sent directly to the user device 106a, or remote access may be granted to the user device 106a. In an alternate embodiment, when the validation is unsuccessful, an error message may be sent to the user device 106a.

At 355, the server system 122 sends a response message to the request for accessing the data service to the user device 106a. The response message may be an access grant, or an error message based on the validation step.

FIG. 4 is a flowchart 400 of a process flow for validating geo-location data of a user device, in accordance with an embodiment of the present disclosure. The process depicted in the flowchart 400 may be executed by, for example, at least one server system such as the server system 200. Operations of the flowchart 400, and combinations of operation in the flowchart 400, may be implemented by, for example, hardware, firmware, a processor, circuitry and/or a different device associated with the execution of software that includes one or more computer program instructions.

At 402, the server system 200 receives a hidden secret key from an authenticator linked to GPS satellite 108a. The hidden secret key corresponds to the transmission of signals between the GPS satellite 108a and a user device such as the user device 106a. The hidden secret key may correspond to the signals from the GPS satellite during the transmission of one or more current messages or recent messages. A new hidden secret may be employed by the GPS satellite 108a for a pre-defined time interval to maintain the security of data transmission.

According to an embodiment, the secret keys are arbitrary strings known to the GPS satellites and disclosed to the authenticator shortly after a signed transmission is sent by a satellite to all receivers. The hidden secret keys are generated by using encrypting techniques as TLS or SSL, or public keys or private keys encryption, or the like to validate the source of the signal, i.e. the GPS satellite. According to an alternative embodiment, the satellite may produce a hash chain of secret keys, using a pre-image of the current hash value received from the satellite and run the hash chain forward a few thousand times to produce a sequence of secrets used to validate the source of the signal, i.e. the GPS satellite.

At 404, the server system 200 matches an orbital geometry associated with the GPS satellite 108a for a current signal with a known orbital geometry of the GPS satellite 108a based, at least in part, on the hidden secret key. The hidden secret key associated with the GPS satellite 108a is analyzed by the server system 200 to validate the orbital geometry of the GPS satellite 108a. The determined orbital geometry may correspond to the current or recent messages transmitted using the signals from the GPS satellite 108a. The orbital geometry of the GPS satellite 108a may be matched with a known orbital geometry of the GPS satellite 108a to validate the source of signal i.e., the GPS satellite 108a.

At 406, in response to the successful match, the server system 200 calculates a time of difference at which the signals were sent between the GPS satellite 108a and the user device 106a and estimates the distance from the expected position of the GPS satellite 108a at the time of transmission to the user device 106a. Then, the server system 200 employs one or more geometric techniques and the speed of light to locate the point at the intersection of one or more spheres surrounding the known orbital position of the GPS satellites. The radius of the sphere is determined as the distance covered at the speed-of-light during the calculated time of difference. The calculated time difference is the difference in time between the time of receipt of messages and the GPS satellite's time as broadcast.

At 408, the server system 200 determines proximity in a distance between the user device 106a and a predetermined physical location. The predetermined physical locations may be geographic areas in which the user 104a is frequently located, for example, the user's place of residence, the user's place of business or the like. The predetermined physical locations may be predetermined in an automated fashion based on monitoring the location of the user 104a in relation to the user device 106a over time.

At 410, the server system 200 generates a geo-location signature based at least on steps 406 and 408. The geo-location signature may include a plurality of location context identifiers associated with the current location of user device 106a. The plurality of location context identifiers may include GPS, IP address, network routing information, nearby trusted devices, and others. Once the geo-location signature has been determined for the user device 106a, it will be used to regulate access to the data service to the user device 106a.

At 412, the server system calculates a confidence level score corresponding to an accuracy of the geo-location signature by comparing location information obtained from the plurality of location context identifiers and rounding off the errors of accuracy of the method from the location context identifiers. The confidence level score increases if more than one and preferably several of the location context identifiers return the similar values to the extent of their own accuracy levels.

Based on the confidence level score and based on these validation result, access to the data service is allowed or denied.

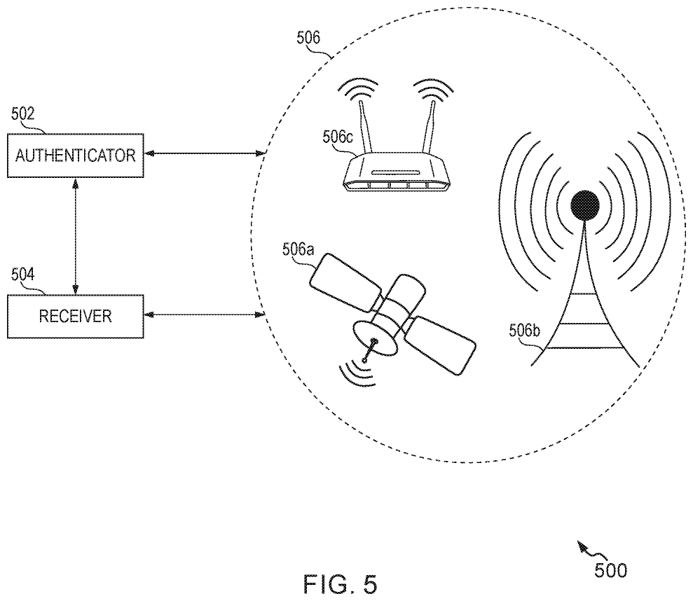

FIG. 5 is an example representation 500 depicting the communication between an authenticator 502 and a receiver 504 linked to a source of signal, in accordance with an embodiment of the present disclosure. The source of signal 506 may include, but not limited to, GPS satellites 506a, a cellular base station 506b, a wireless network router 506c, etc.

The authenticator 502 may be an entity that is linked to the GPS satellite and is configured to store and distribute hidden secret keys employed by the GPS satellites for secure communication. The hidden secret keys may be used by the server system 200 for validating the geo-location data of the user devices 106 as described in FIG. 4. The authenticator 504 implements an enhanced mechanism, extending existing IETF standards, to authenticate GPS signals to ensure that they are from trusted satellites and have not been spoofed. Further, the authenticator 504 is configured to locate a point at which the trust is established at a well-connected and well-known terrestrial location. The authenticator 504 helps in building a shared blackboard to enhance trust in the reported locations of colleagues' devices.

The receiver 504 may be linked to one or more geo-location data sources, such as GPS satellite 506a, the cellular base station 506b, wireless devices such as the wireless network router 506c, etc. The geo-location data sources may also be basic service set identification (BSSID) location service, and/or carrier mobile tower(s) using the cellular radio of the user device 106a.

The authenticator 502 and the receiver 504 are configured to communicate with the sources of signal 506 (such as, the GPS satellite 506a) and transmit information related to the sources of signals to the user devices. The receiver 504 is configured to analyze the geo-location of the user device upon receiving the request to access data service from the user device and send it to the server system 200. The server system 200 may utilize the geo-location data sent by the receiver 504 to authenticate the user devices 106 for granting access to the data service.

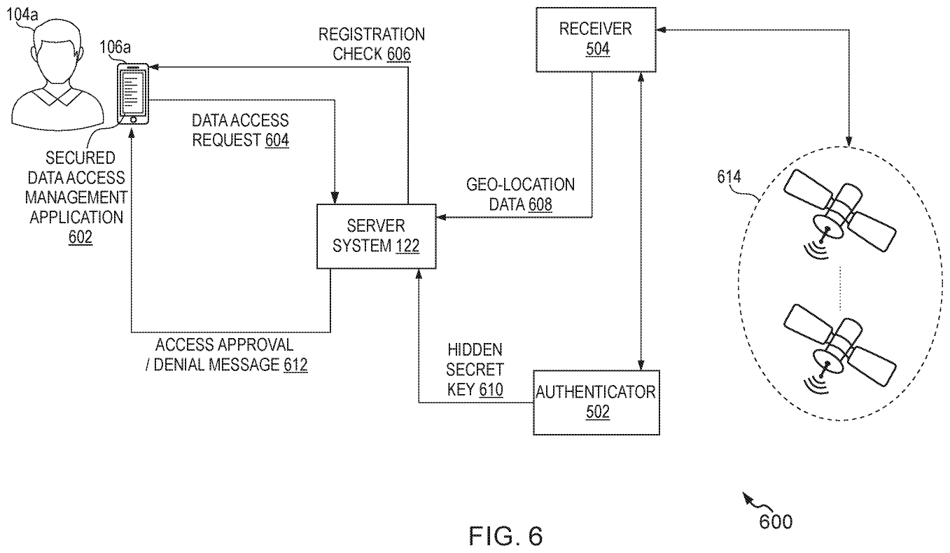

FIG. 6 represents an example representation 600 for validating a user device 106a to access a data service from the server system 122, in accordance with an example embodiment of the present disclosure.

In one example, the user may be an office employee working from home and wishing to access a file from the server system 122. The user device 106a may be registered with the server system 122 via a secure data access management application 602. The user 104a may initiate a request to access a data service regarding his office work from his home using the secure data access management application 602 on the user device 106a. The data access request may be sent from the user device 106a to the server system 122 (see, 604). The server system 122 may perform a registration check (see, 606) upon receipt of the data access request from the user device 106a. The registration check may include determining whether the user device 106a is registered with secure data access management application 602 or not.

Once the user 104a and the user device 106a are found to be registered, the server system 122 is configured to communicate with the receiver 504 (referred to FIG. 5) associated with a source of signal (such as, GPS satellites 614) for determining the geo-location data of the user device 106a. The receiver 504 may be linked to the GPS satellites 614 and may send the geo-location data (see, 608) of the user device 106a to the server system 122. The geo-location data may be digitally signed by the receiver using, for example, secure sockets layer (SSL) or transport layer security (TLS), using a government-issued private encryption key.

Thereafter, the server system 122 may initiate a communication with the authenticator 502 (referred to FIG. 5). The authenticator 502 is also linked to the GPS satellites 614 and may determine recently used hidden secret keys by the GPS satellites 614 for signal transmissions. The authenticator 502 may transmit the hidden secret key associated with the last message or a recent message (see, 610) that is used to sign the transmissions with the user device address and is known only to the GPS satellites 614 at the time of broadcast. Following this transmission, after a few seconds, the authenticator 502 learns and discloses the hidden secret key and satellite identifier of the current signal or the signal that was last originated, after verifying that the hidden secret key it receives from the GPS satellites 614 matches the authentication cypher of recent transmissions received from that GPS satellites 614 or forwarded to it by recipients in the broadcast shadow of the GPS satellites 614. The server system 122 then analyses the received secret keys to match the orbital geometry of the source of signals to the satellites for the current or recent message(s) to ensure that the geometry corresponds to the expected orbital geometry of the satellite and the known fixed location of the authenticator 502.

The server system 122 is configured to generate a geo-location signature based on the validation and compare the geo-location signature and the geo-fence in an access policy. When the geo-location in the geo-location signature and the geo-fence in the access policy meet a matching threshold condition, the server system 122 is configured to validate the user device 106a and grant the user device 106a to access the data service. In the example, the access geo-location associated with the data service includes geo-location of the home of the user 104a. The geo-fence may be generated based on the access policy using the access geo-location associated with the data service. The server system 122 may then send access granted message and provide access to the data requested by the user 104a (see, 612). The data requested by the user may be fully transferred to the user device 106a or the user device 106a may be allowed to remotely access the requested document or data.

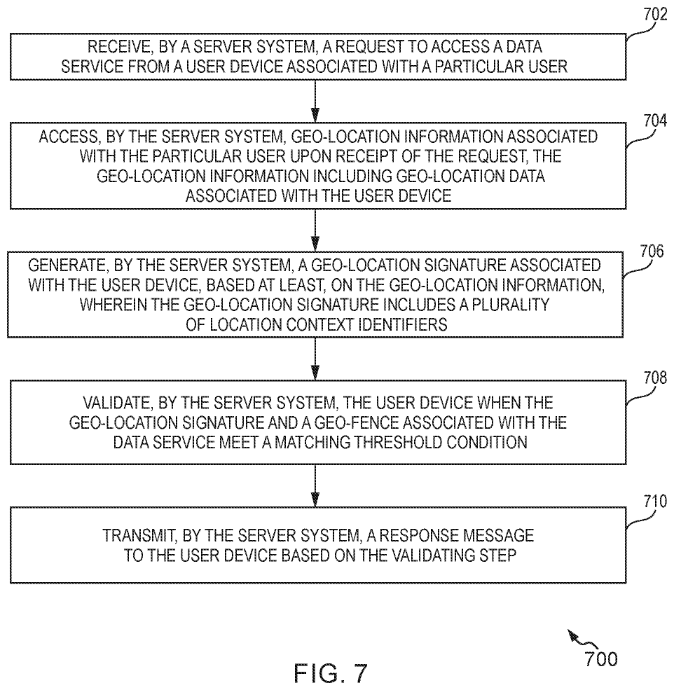

FIG. 7 is a flow diagram of a method 700 for verifying data access requests by location-based validation, in accordance with an embodiment of the present disclosure. The method 700 depicted in the flow diagram may be executed by, for example, the at least one server system such as the server system 200. Operations of the flow diagram of method 700, and combinations of operation in the flow diagram of method 700, may be implemented by, for example, hardware, firmware, a processor, circuitry and/or a different device associated with the execution of software that includes one or more computer program instructions. The method 700 starts at operation 702.

At 702, the method 700 includes receiving a request to access a data service from a user device such as the user device 106a associated with a particular user such as the user 104a.

At 704, the method 700 includes accessing geo-location information associated with the particular user such as the user 104a upon receipt of the request. The geo-location information includes geo-location data associated with the user device such as the user device 106a.

At 706, the method 700 includes generating a geo-location signature associated with the user device such as the user device 106a, based, at least, on the geo-location information. The geo-location signature includes a plurality of location context identifiers.

At 708, the method 700 includes validating the user device such as the user device 106a when the geo-location signature and a geo-fence associated with the data service meet a matching threshold condition. The geo-fence is defined based on an access geo-location and an access policy with location restricted access for the data service.

At 710, the method 700 includes transmitting a response message to the user device 106a based on the validating step.

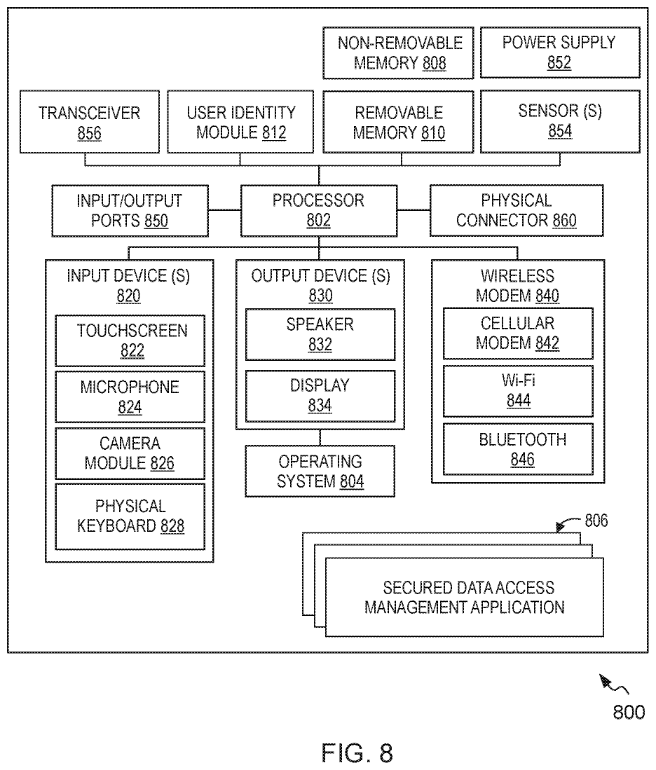

FIG. 8 shows simplified block diagram of an electronic device 800 for example a mobile phone or a desktop computer capable of implementing the various embodiments of the present disclosure. For example, the electronic device 800 may correspond to the user devices 106a and 106b of FIG. 1A. The electronic device 800 is depicted to include one or more applications such as a secured data access management (SDAM) application 806 facilitated by the server system 200. The SDAM application 806 can be an instance of an application downloaded from the server system 200 or a third-party server. The data access application 806 is capable of communicating with the server system 200 for facilitating multi-factored location validation of one of the user devices for accessing a location restricted data service.

It should be understood that the electronic device 800 as illustrated and hereinafter described is merely illustrative of one type of device and should not be taken to limit the scope of the embodiments. As such, it should be appreciated that at least some of the components described below in connection with the electronic device 800 may be optional and thus in an example embodiment may include more, less or different components than those described in connection with the example embodiment of the FIG. 8. As such, among other examples, the electronic device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the user device 800 and support for one or more payment transaction applications programs such as the data access application 806, that implements one or more of the innovative features described herein. In addition to the data access application 806, the applications may include common mobile computing applications (e.g., telephony applications, email applications, calendars, contact managers, web browsers, and messaging applications) or any other computing application.

The illustrated electronic device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the C2C applications 806. The electronic device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution) or later such as 5G.

The electronic device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to, a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the electronic device 800 and a public switched telephone network (PSTN).

The electronic device 800 can further include one or more input/output ports 850, a power supply 852, one or more sensors 854 for example, an accelerometer, a gyroscope, a compass, or an infrared proximity sensor for detecting the orientation or motion of the electronic device 800 and biometric sensors for scanning biometric identity of an authorized user, a transceiver 856 (for wirelessly transmitting analog or digital signals) and/or a physical connector 860, which can be a USB port, IEEE 794 (FireWire) port, and/or RS-230 port. The illustrated components are not required or all-inclusive, as any of the components shown can be deleted and other components can be added.

The disclosed method with reference to FIG. 7, or one or more operations of the method 700 may be implemented using software including computer-executable instructions stored on one or more computer-readable media (e.g., non-transitory computer-readable media, such as one or more optical media discs, volatile memory components (e.g., DRAM or SRAM)), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fibre optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 200 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method comprising:
receiving, by a server system, a request to access a data service from a user device associated with a particular user;
accessing, by the server system, geo-location information associated with the particular user upon receipt of the request, the geo-location information comprising geo-location data associated with the user device;
generating, by the server system, a geo-location signature associated with the user device, based at least, on the geo-location information, wherein the geo-location signature comprises a plurality of location context identifiers;
validating, by the server system, the user device when the geo-location signature and a geo-fence associated with the data service meet a matching threshold condition; and
transmitting, by the server system, a response message to the user device based on the validating step.

2. The computer-implemented method as claimed in claim 1, wherein the geo-fence is defined based, at least in part, on an access geo-location and an access policy with location restricted access for the data service.

3. The computer-implemented method as claimed in claim 1, further comprising validating, a source of signal based, at least in part, on:
receiving, by the server system, a hidden secret key from an authenticator linked to the source of signal, wherein the hidden secret key corresponds to transmissions of signals between the source of signal and the user device;
matching, by the server system, an orbital geometry associated with the source of signal for a current signal with a known orbital geometry of the source of signal based, at least in part, on the hidden secret key; and
in response to a successful match, determining, by the server system, geo-location associated with the geo-location signature based, at least in part, on a distance from a position of the source of signal at a time of transmission to the user device.

4. The computer-implemented method as claimed in claim 3, wherein the source of signal is associated with one of: global positioning system (GPS) satellites, basic service set identification (BSSID) location service, carrier mobile towers, and wireless network routers.

5. The computer-implemented method as claimed in claim 1, wherein validating the user device comprises comparing the geo-location signature with the geo-fence.

6. The computer-implemented method as claimed in claim 1, further comprising determining, by the server system, the geo-location data of the user device based, at least in part, on one or more location indicators, the one or more location indicators comprising GPS service, IP addresses, nearby cell towers' location, and prior authenticated user devices.

7. The computer-implemented method as claimed in claim 1, further comprising calculating, by the server system, a confidence level score corresponding to an accuracy of the geo-location signature associated with the user device.

8. The computer-implemented method as claimed in claim 7, further comprising providing, by the server system, access rights to the user device for the data service based on the validating step and the confidence level score.

9. A server system, comprising:
a memory configured to store instructions;
a communication interface; and
a processor in communication with the memory and the communication interface, the processor configured to execute the instructions stored in the memory and thereby cause the server system to perform at least in part to:
receive a request to access a data service from a user device associated with a particular user,
access geo-location information associated with the particular user upon receipt of the request, the geo-location information comprising geo-location data associated with the user device,
generate a geo-location signature associated with the user device, based, at least, on the geo-location information, the geo-location signature comprising a plurality of location context identifiers,
validate the user device when the geo-location signature and a geo-fence associated with the data service meet a matching threshold condition, and
transmit a response message to the user device based on the validation.

10. The server system as claimed in claim 9, wherein the geo-fence is defined based, at least in part, on an access geo-location and an access policy associated with the data service with location restricted access.

11. The server system as claimed in claim 9, wherein, to validate a source of signal, the server system is further caused to:
receive a hidden secret key from an authenticator linked to the source of signal, wherein the hidden secret key corresponds to transmissions of signals between the source of signal and the user device;
match an orbital geometry associated with the source of signal for a current signal with a known orbital geometry of the source of signal based, at least in part, on the hidden secret key; and
in response to a successful match, determine geo location associated with the geo-location signature based, at least in part, on a distance from a position of the source of signal at a time of transmission to the user device.

12. The server system as claimed in claim 11, wherein the source of signal is associated with one of: global positioning system (GPS) satellites, basic service set identification (BSSID) location service, carrier mobile towers, and wireless network routers.

13. The server system as claimed in claim 9, wherein, to validate the user device, the server system is further caused to compare the geo-location signature with the geo-fence.

14. The server system as claimed in claim 9, wherein the server system is further caused to determine the geo-location data of the user device based on one or more location indicators, the one or more location indicators comprising GPS service, IP addresses, nearby cell towers' location, and prior authenticated user devices.

15. The server system as claimed in claim 9, wherein the server system is further caused to calculate a confidence level score corresponding to an accuracy of the geo-location signature associated with the user device.

16. The server system as claimed in claim 15, wherein the server system is further caused to provide access rights to the user device for the data service based on the validating step and the confidence level score.

17. A computer-implemented method for adaptive multi-factored geo-location based data service access rights management and enforcement, the computer-implemented method comprising:
receiving, by a server system, a request to access a data service from a user device associated with a particular user;
accessing, by the server system, geo-location information associated with the particular user upon receipt of the request, the geo-location information comprising geo-location data associated with the user device;
generating, by the server system, a geo-location signature associated with the user device, based, at least, on the geo-location information, wherein the geo-location signature comprises a plurality of location context identifiers;
validating, by the server system, the user device when the geo-location signature and a geo-fence associated with the data service meet a matching threshold condition; and
transmitting, by the server system, a response message to the user device based on the validating step.

18. The computer-implemented method as claimed in claim 17, wherein validating the user device comprises comparing, by the server system, the geo-location signature with the geo-fence of the data service, the geo-fence defined based, at least in part, on an access geo-location and an access policy associated with the data service.

19. The computer-implemented method as claimed in claim 17, further comprising determining, by the server system, the geo-location data of the user device based, at least in part, on one or more location indicators, the one or more location indicators comprising GPS service, IP addresses, nearby cell towers' location, and prior authenticated user devices.

20. The computer-implemented method as claimed in claim 17, further comprising providing, by the server system, access rights to the user device for the data service in response to successful validation of the user device.
